(19) United States
(12) Patent Application Publication
(10) Pub. No.: US 2008/0261526 A1
(43) Pub. Date: Oct. 23, 2008

(54) IDENTIFYING AND REACHING USERS THROUGH MOBILE DEVICES TO PROVIDE RELEVANT AND REAL-TIME INFORMATION

(76) Inventor: Narashima Suresh, Bangalore (IN)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/107,519

(22) Filed: Apr. 22, 2008

(30) Foreign Application Priority Data
Apr. 23, 2007 (IN) 859/CHE/2007

(51) Int. Cl. H04M 3/42; H04B 7/00; H04Q 7/20

(52) U.S. Cl. 455/41.2; 455/414.2; 455/466

(57) ABSTRACT

A method to identify and reach users of mobile devices to provide relevant and real-time information including discount coupons and promotional messages is disclosed. The present invention uses short range connectivity present in most mobile devices to identify mobile devices and reaches the mobile devices using long range or short range communication to provide relevant and real-time information. In one embodiment, the present invention enables identifying new and existing members in stores implementing customer loyalty programs to effectively share information about discounts and promotions with existing customers and convert prospective customers in new members. In another embodiment, the present invention enables tracking of user in events including trade shows, exhibitions, seminars, city tours etc, to provide relevant and real-time information based on the location and the needs of the user.

The present application is based on, and claims priority from, IN Application Number 859/CHE/2007, filed Apr. 23, 2007, the disclosure of which is hereby incorporated by reference herein.

### FIELD OF THE INVENTION

The present invention relates to the field of mobile communications. More particularly, the present invention is related to identifying and reaching users through their mobile devices to provide relevant and real-time information.

### BACKGROUND AND PRIOR ART

Advances in communication technologies and adoption of those technologies have led to a highly mobile life style in society in general. The mobile life style demands instant information that people can use to reduce the time they spend in processing and analyzing information.

Over the past two decades, Internet has been used to share information and as a communication means in general. People could search on the Internet about a place they are visiting or a store they are visiting before they actually are on the move. Such a process is very time consuming and information is not real time. It is possible that the information about inventory in a store as shown on the Internet is outdated. Besides people do not have the time to spend to collect and analyze information.

As an example, companies use discount coupons as a way to market their products. Earlier, coupons were distributed by attaching coupons to newspapers. Today we have online coupons. Coupons are also directly mailed to addresses obtained through various mailing lists regardless of the person staying at the mail address. There are also companies that distribute coupons through mobile devices.

For coupons to be effective users need to have the right coupons and at the time they actually need it. Online coupons and coupons on mobile devices make life a little easier as users do not have to sit and spend a lot of time on cutting and organizing coupons that will be useful. However, there still exists inefficiency in the process of distributing coupons. Companies are not sure whether their coupons reach the right people, at the right time and end up distributing coupons through multiple channels. Users have to spend a fair amount of time in searching for and organizing the coupons that may be useful to them in future.

There exists a need for a system where users and their needs are identified, and relevant and real-time information including coupons and promotional messages are distributed to users based on their interests and needs in real time when they actually need it. Today Bluetooth connectivity is commonly available in most mobile devices. Hence Bluetooth connectivity and similar short range connectivity can be effectively used to identify and reach users in various contexts to provide relevant and real-time information. The present invention provides a method and system to identify and reach users of mobile devices with short range connectivity like Bluetooth for providing relevant and real-time information including discount coupons and promotions according to the interests and needs of the user.

### SUMMARY OF THE INVENTION

Accordingly, in one aspect, the present invention provides a system to enable identifying and reaching users to provide relevant and real-time information, where users are identified through their mobile devices. The system comprises of a plurality of access nodes, each access node comprising of multiple components of short range radio, expandable memory, digital signal processor for processing audio, video and images; a server for storing, processing and communicating user information and information programs; and plurality of mobile devices of users with at least a radio for short range connectivity.

In another aspect, the present invention provides a method for identifying and reaching users to provide relevant and real-time information to users and businesses.

The method enables collecting information about users based on the interactions of users at multiple access nodes and the information provided by the users themselves.

In a preferred embodiment of the method, the present invention allows businesses identifying and reaching existing and new customers so that customers can view latest information including new discounts available to members. Existing customers can be shown relevant information including discounts based on their profiles. New customers can be shown the benefits of becoming members and hence help in converting new customers in to members. Identifying and reaching customers happen through the mobile devices of customers having short range connectivity and/or capability to send SMS messages.

In another preferred embodiment of the method, the present invention provides a method to identify and reach users at an event where users are tracked by their movement using a short range connectivity of the mobile devices carried by the users to send specific information including discount coupons and promotions that they might be interested relating to the places that they are visiting or they might be visiting. The event could be a trade show, a general exhibition or even a tour of a city.

The present invention provides algorithms and mechanisms for integrating widely available technologies to identify and reach users of mobile devices, and collect real time information about them to provide real time information to both users and businesses when they need it with least intervention of the user himself. The present invention does not require users of mobile devices to have any preloaded applications to use or access such useful information and hence is time and cost effective.

### BRIEF DESCRIPTION OF THE DRAWINGS

Further objects, features and advantages will become apparent from the following description, claims, and drawings, where:

FIG. 1 shows the system of the invention and the various components in the system;

FIGS. 2A and 2B are block diagrams showing the various blocks that the access nodes and the servers are made of respectively;

FIG. 3 shows a configuration in one embodiment where a single server caters to multiple stores within a region, the configuration being referred to as a cluster;

FIG. 4 shows a configuration in one embodiment where servers in multiple clusters are interconnected;

FIGS. 5A and 5B show a flow diagram according to one embodiment of the method of the invention;

FIGS. 6A and 6B show a flow diagram according to one embodiment of the method of the invention;

FIG. 7 shows a flow diagram according to one embodiment of the method of the invention;

FIG. 8 shows a flow diagram according to one embodiment of the method of the invention;

FIG. 9 shows a flow diagram according to one embodiment of the method of the invention;

FIG. 10 shows a flow diagram according to one embodiment of the method of the invention;

FIG. 11 shows a flow diagram according to one embodiment of the method of the invention;

FIG. 12 shows a flow diagram according to one embodiment of the method of the invention;

FIG. 13 shows a geographical representation of an event where there are multiple access nodes deployed to track users; and

FIG. 14 shows a flow diagram according to one embodiment of the method of the invention; and

FIG. 15 shows a flow diagram according to one embodiment of the method of the invention.

### DETAILED DESCRIPTION OF THE PREFERRED EMBODIMENTS

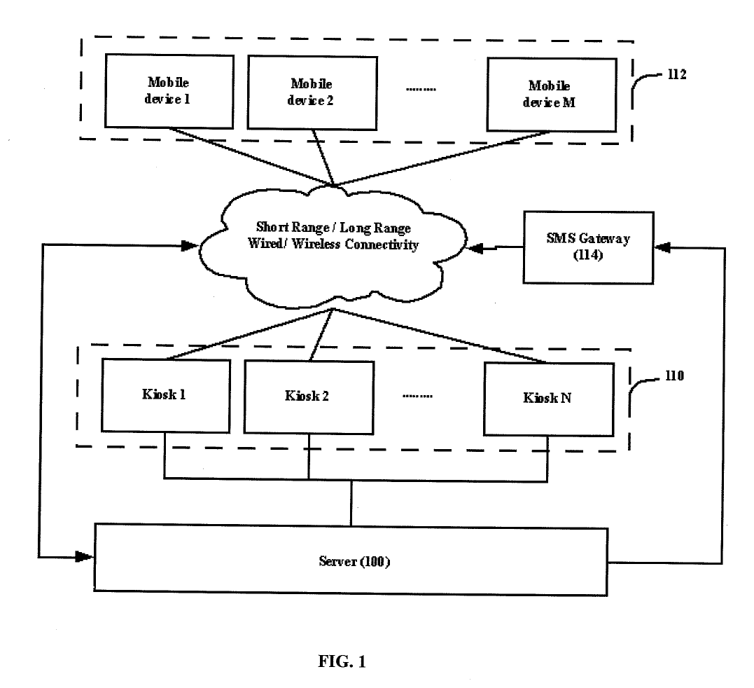

FIG. 1 shows the system of the invention. The system comprises of a plurality of access nodes (110); a server (100) for storing, processing and communicating user information (including user profile information, other related information like context information and loyalty program information); and plurality of mobile devices (112) of new and existing customers with at least a radio for short range connectivity, an optional capability to send messages, and an optional capability to run custom applications to be downloaded from said access nodes. A mobile device is any hand help device capable of short range and/or long range communication including but not limited to mobile phones, smart phones and PDAs. The server further comprises of a server application (108) to manage the information flow. The server comprises of a Mobile originated (MO) and Mobile Terminated (MT) interface to a SMS gateway (114). The server uses the MO interface to receive SMS from end users mobile device and deliver relevant information to the user mobile using SMS through the MT interface.

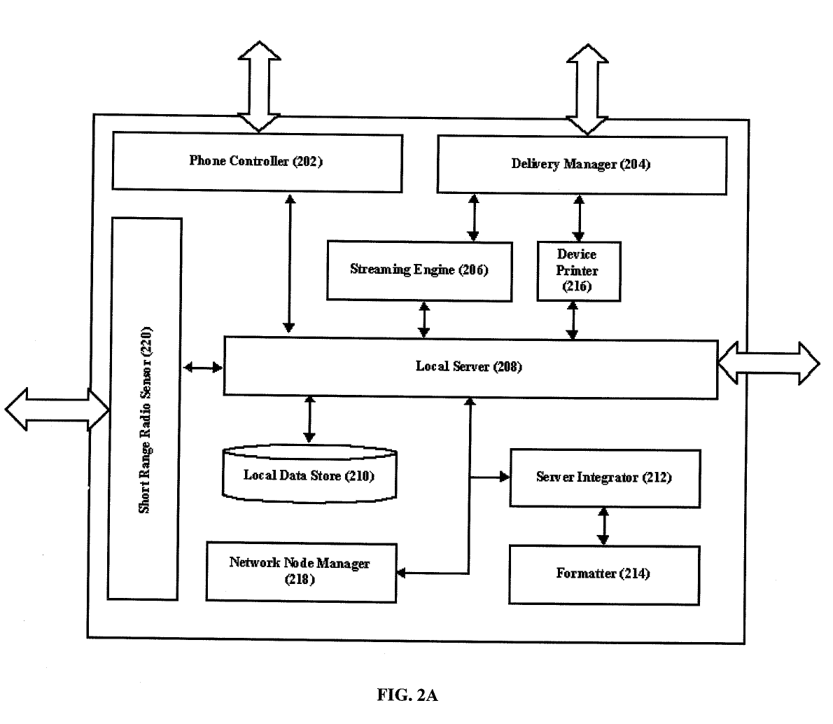

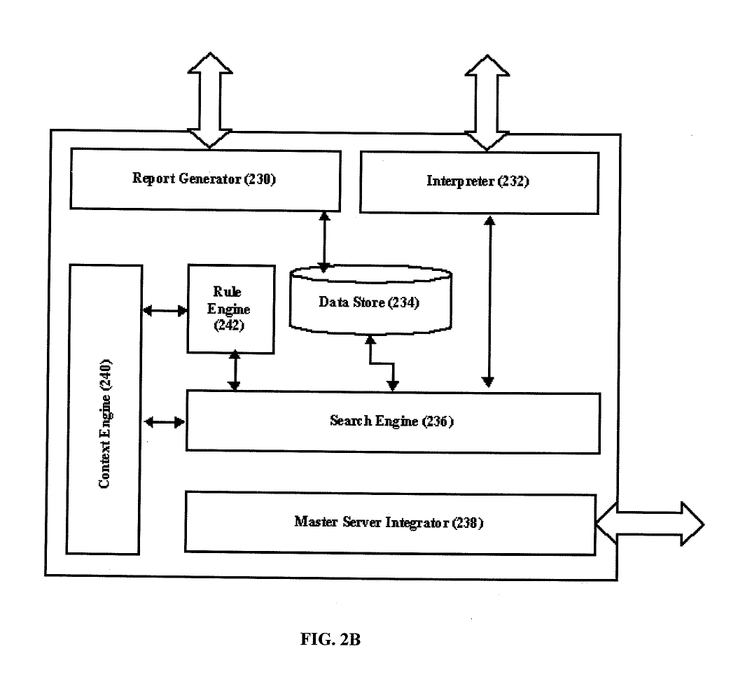

An access node comprises of a processing unit, expandable memory and multiple components of short range radio communication. An access node may also include a touch screen monitor for allowing users to interact with the access node. In an embodiment the access node is a self-contained computer system comprising of components mentioned herein. In an embodiment the short range radio mainly works in the Industrial, Scientific and Medical (ISM) band which can be used without obtaining a license from regulators. In another embodiment, an access point is an independent box that can be hanged on to wall or kept in an invisible location. FIG. 2A is a block diagram showing various blocks that comprise an access node. An access node typically comprises of a short range radio sensor (220), a delivery manager (204), a phone controller (202), a streaming engine (206), a local server (208), a local data store (210), a formatter (214), a device printer (216), a server integrator (212), and a network node integrator (218).

Short range radio sensor (220) would capture the devices in the range of the sensor which can communicate with the access node and identify mobile devices and other accessories supporting the short range radio. When identified, all the captured information is sent to other processing components of the access node through the Local server (208).

Delivery manager (204) manages the delivery of content/information to mobile devices or applications running on mobile devices. Delivery manager (204) handles all adoptions with the device including and not limited to communication and protocol. Phone controller (202) would communicate with the target device using the mechanisms such as AT commands to realize some of the provisioning functionalities like sending an SMS requesting a call back amongst other things. Short range local server (208) would receive messages and information from the clients. This component enables users to upload a file, image, video or text from their phone to access point. This would enable users to define their requirement through different media (for example, taking a picture, sending a audio, sending a video, writing a search string amongst other things). Some of the examples where the server is involved include: user taking a picture of the product about which he needs more information/discounts and sending the same through Bluetooth; user sending the bar code associated with a product for getting better discounts for being loyalty member; user responding to a quiz by taking a picture and uploading the image; user selecting an option in a custom application downloaded from the access node; and user entering the search string in a notepad and sending it through Bluetooth for search.

Streaming engine (206) in conjunction with device adaptor would handle streaming of files and multi media to target mobile devices.

Local data store (210) stores all the meta information required for functioning of the access node.

Configuration manager stores the information delivered by the server on configuration.

Local server (208) stores the information delivered by the server on configuration. The information stored by the server includes the server this particular access node should connect to, the name of the access node and the services the access node is enabled to offer. Examples of the services the access node can be enabled to offer include start and stop streaming server, communication over AT channels, contacting other access nodes connected to the system. Local server (208) also acts as a conduit for information flow with in the access node between various blocks as disclosed herein.

Formatter (214) formats and encrypts the requests from the access point to server.

Device printer (216) identifies the make and model of the device communicating with the system by the radio id and/or BDADDR of the device which would allow access point to fine tune the mode and format communication with the device.

The content is adapted to the format and screen dimensions of the mobile by the Content Adaptation Engine.

Server integrator (212) would communicate with central server (100) both on demand and at scheduled interval for retrieving communication instructions and for polling any configuration details. This would enable access point to function inside a private network and behind the firewall. Also, server integrator (212) communicates with formatter (212) for formatting and encrypting requests to be sent to server (100).

Network node integrator (218) performs the function of a node in mesh networking. Access points in a location would form an intelligent network (PAN) which would enable the system to work as one and share information on the users.

Server (100) also receives signals from the access point for identifying the communication to be delivered to end user. Communication can both depend on context sensitive communication engine and on user interactions (for example, if user uploads image or text, a new functionality can be derived from this context).

FIG. 2B is a block diagram showing the various blocks of a server. A server comprises of an interpreter (232), a search engine (236), a context engine (240), a rule engine (242), a master server integrator (238), a data store (234) and a report generator (230).

Interpreter (232) interprets the request from the user encapsulated by formatter (214) and with the help of rule engine (242) to generate an input required by context engine (240). If the request is a query string/image/audio/video, the request is delivered to search engine (236) where the search engine would interpret the request, searches in data store (234) and returns the best possible result that is provided to rule engine (242) which would generate the input required for context engine (240). The search engine is typically a multi media search engine and is capable of performing various functions which include but the engine is not limited to:

1. Pre-Request
a) index set of images, texts, video and audio
b) Associate unique patterns identified with the content indexed
c) Identify alternative patterns that can represent the same object

2. On request
a) Generate a pattern out of requested object
b) Match the pattern of requested unit with the indexed database
c) On matching return the identifier representing the matched database,
d) Identifier is delivered to rule engine which would provide the required inputs for context sensitive engine.

Master Server integrator (238) integrates multiple node servers (208) kept in different locations to integrate with central server (100) for licensing and campaign related information. This also enables server to be placed inside firewalls.

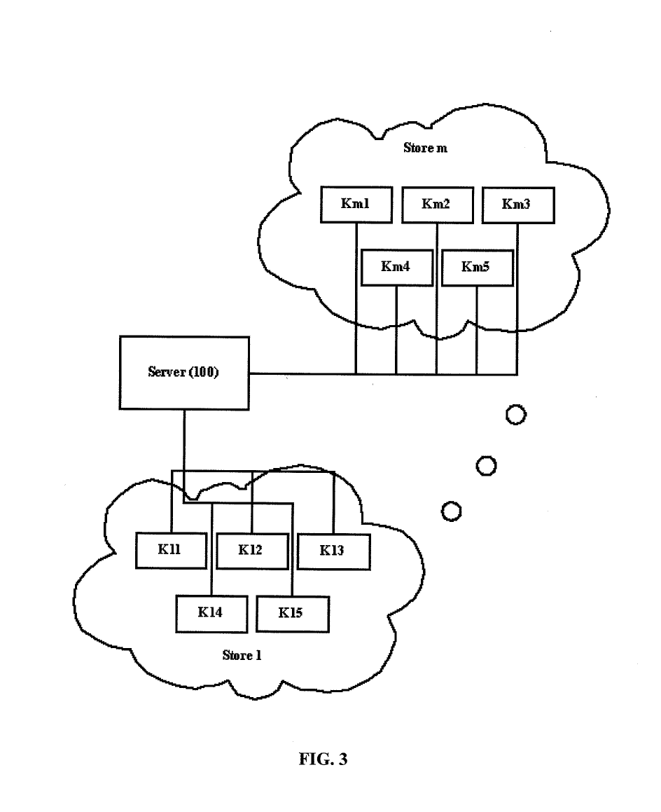

The system could be deployed in multiple ways. In one embodiment, as shown in FIG. 3, the system could be deployed across a chain of stores. In this embodiment, a plurality of access nodes can be deployed in each store as part of the store chain. A common server could be deployed that is common to all the stores. Shown in FIG. 3 are a plurality of stores numbering from 1 to m, where each of the stores have a plurality of access nodes deployed. All the access node deployments in all the stores in combination with the server could be thought of as a cluster. The cluster could be defined based on a region (for example, a city or a state).

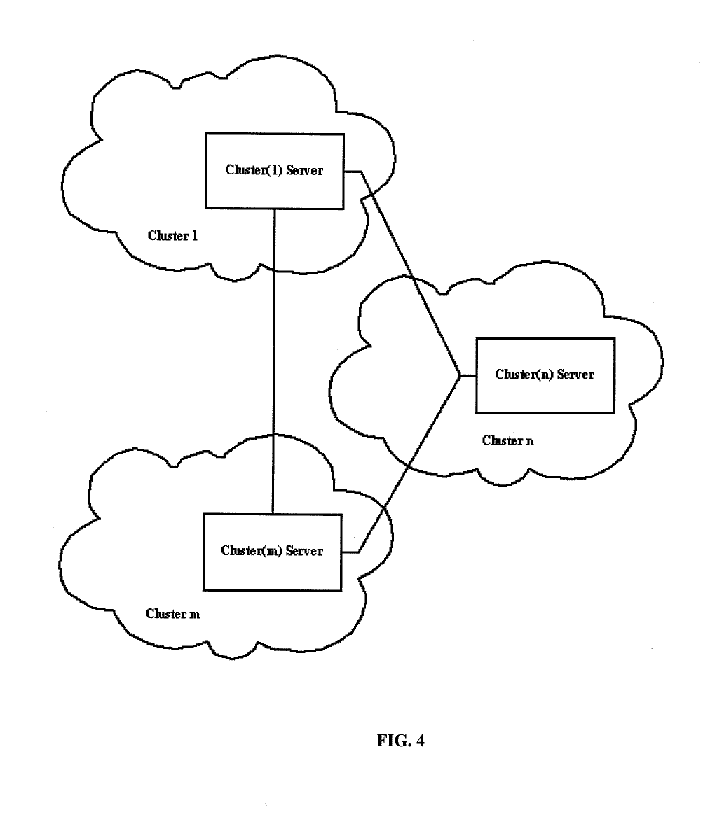

FIG. 4 shows interconnection between the servers of multiple clusters (clusters 1 to n) as described using FIG. 3. Such interconnection enables sharing of information across clusters (for examples, across cities or states). For example, a registered user might be regularly shopping in a store chain X in a cluster (cluster 1) as shown in FIG. 3 belonging to state A. The interconnection between clusters allows transfer of information across clusters and therefore enables identifying the user even though he travels to another cluster (cluster m) belonging to state B.

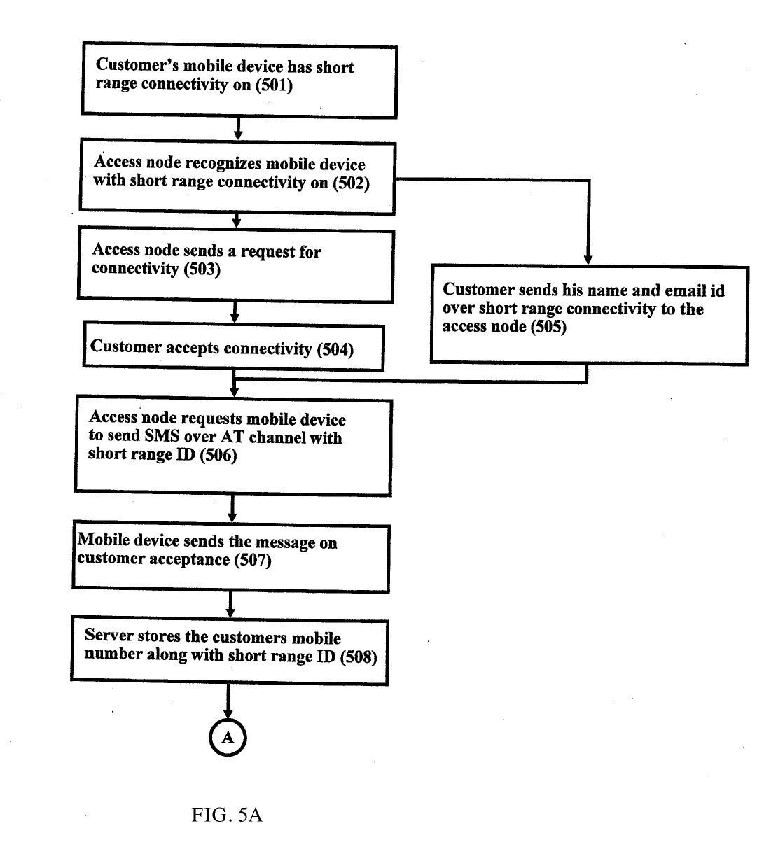

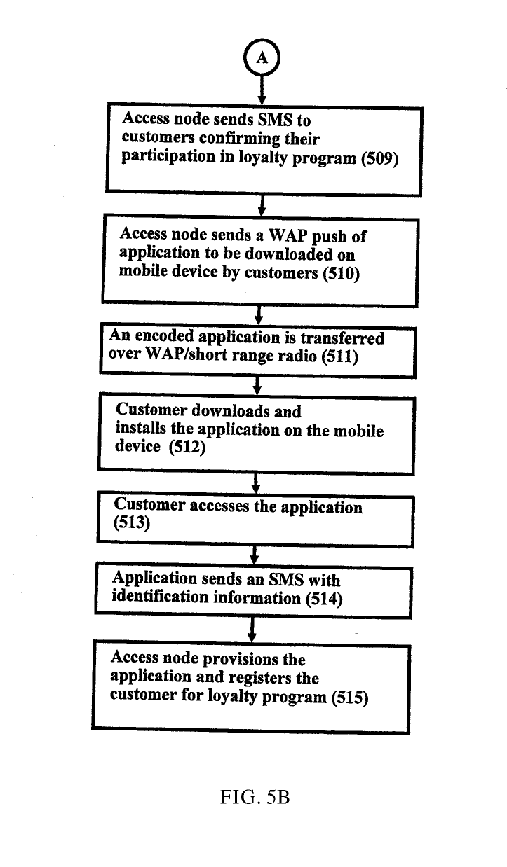

FIGS. 5A and 5B illustrate the flow of the method for identifying and reaching new and existing customers to sign up to loyalty program, where mobile devices of customers have short range connectivity like Bluetooth and have capability to send SMS messages. The method comprising the steps of a customer having short range connectivity activated on his mobile device (501); the access node recognizing the mobile device which has short range connectivity activated (502) and the access node sending the mobile device a request for connectivity (503). Once the customer accepts the connectivity request (504), the mobile device is requested by the access node to send an SMS with a short range ID over the AT channel (506). The short range ID is a unique combination of the customers' phone number along with the Bluetooth ID of the mobile device. The customer also has an option to send his name and email ID over short range connectivity to the access node (505). On receiving the SMS, the access node requests the mobile device to send a SMS over the AT channel with the short range ID (506). Once the customer accepts the request, a SMS is sent to the access node (507). The customer's mobile number along with short range ID is stored in the server (508). The server sends an SMS to the customer confirming their participation in loyalty program (509). The access node sends a WAP push to customers asking them to download an application specific to the mobile device, the application being associated with the unique ID (510). The application is transferred to the customer's mobile device over WAP/short range radio through the access node, the application being encoded with the unique ID based on the Bluetooth id and mobile number (511). The customer downloads the application and installs the same on the mobile device (512). On the customer opening the application for the first time (513), the access node directs the mobile application to send an SMS message to the server with Bluetooth id without the intervention of the customer (514). The server provisions the application and registers the customer for loyalty program (515) when the application signature matches with the application signature stored on the server, the application signature being based on the Bluetooth id and mobile number originally obtained from the customer's mobile device. The application signature is included in every request that goes from the client application on the mobile devices to the server.

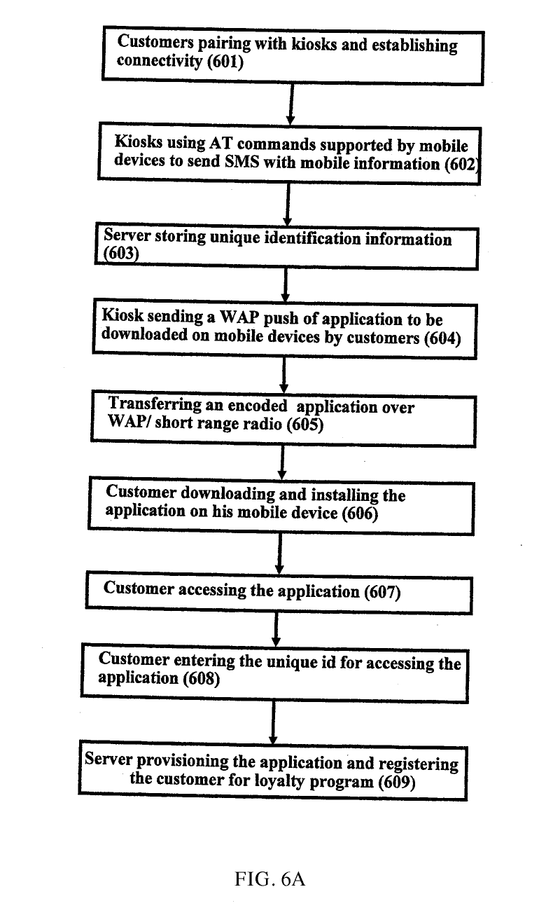

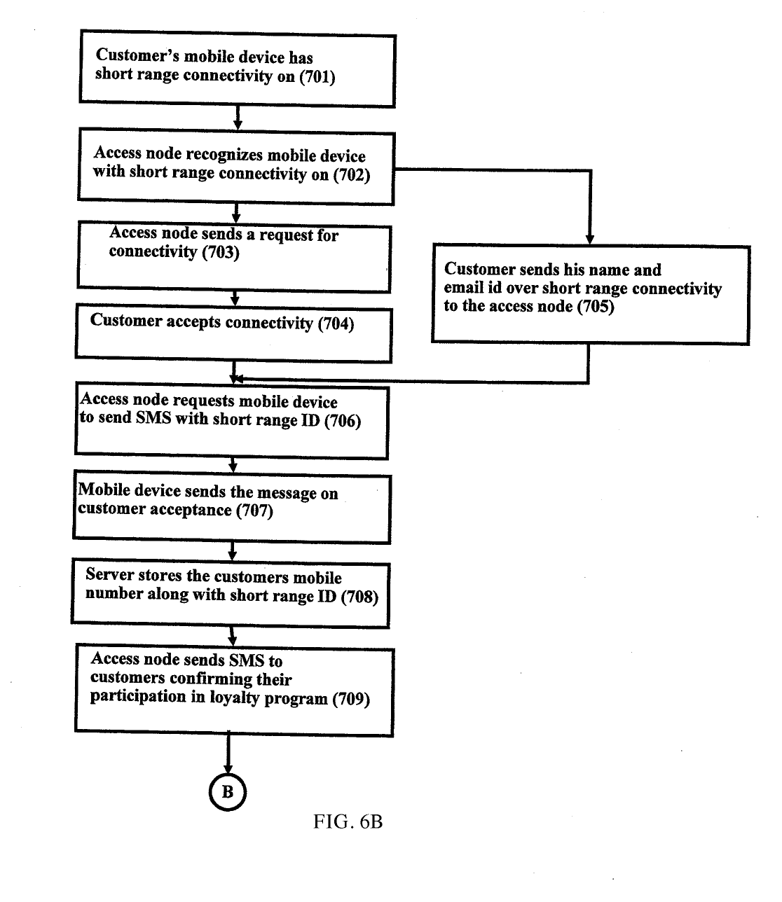

FIGS. 6A and 6B show the flow for another embodiment of the method for identifying and reaching new and existing customers to sign up to loyalty program, the method supporting mobile devices of customers that have short range connectivity like Bluetooth and do not have capability to send SMS messages, the method comprising the steps of customers pairing with the access node over short range connectivity and establishing physical connectivity (601); access node using AT commands supported by mobile devices for sending an SMS to server with the information on short range id and mobile number of the found device (602); storing unique ID (combination of the short range id and mobile number) on the server (603); access node sending a WAP push to customers asking them to download an application specific to the mobile device, the application being associated with the unique ID (604); transferring the application based on the customers mobile device over WAP/short range radio through the access node, the application being encoded with the unique ID based on the Bluetooth id and mobile number (605); customer downloading the application and installing the same (606); customer opening the application for the first time (607); customer entering a unique id that he received through the SMS that confirmed the customer's participation in loyalty program (608); server provisioning the application and registering the customer for loyalty program (609) when the application signature matches with the application signature stored on the server, the application signature being based on the Bluetooth id and mobile number originally obtained from the customer's mobile device. The application signature is included in every request that goes from the client application on the mobile devices to the server.

Connection of customers with access nodes involves, when a customer comes near a access node with his short range radio turned on, unique identifier (for example, combination of the Bluetooth id and mobile number) associated with short range radio is sent to server along with location of the hot spot (access node) and time lines. Server on receiving the information would map the radio id with other information on the customer including but not limited to mobile number, name of the customer, and/or buying history. Upon mapping information, server can deliver information/promotions with the available information. As the server has the knowledge of the mobile number of the customer, communication can be delivered back through short range video or through a long range communication technology like SMS/call. Rule engine (242) of the server (100) can look for identifiers that have particular behaviour like “Frequently visiting”, “Not visiting”, or “Visiting at particular time line” and help server (100) initiate communication based on the same. Server also stores all the information sent by access node to build the profile including the content delivered to customer in response to identification, activity of customer downloading and using the same. Reference may be made to an earlier application U.S. Ser. No. 11/734,302 claiming priority of IN application 1376/CHE/2006 by the inventors, which discloses in detail a model for generating user context. As disclosed in U.S. Ser. No. 11/734,302, server can generate the context of a customer who is interacting with the access points with the help of context engine and rule engine. Please refer to U.S. Ser. No. 11/734,302 for more details on the role of context and rule engines as details relating to context engine and rule engine are central to the present invention. For example, a customer can use an application to tell the access point what he is looking for. In this case, information on user's access point id, timeline, information that the user is looking for (category/search string), short range id are sent to server for storing the user request and also for identifying proper communication.

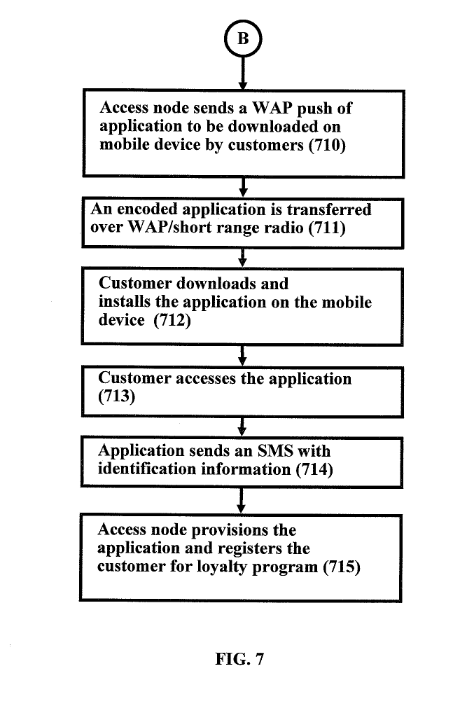

FIG. 7 shows the flow for another embodiment of the method for identifying and reaching new and existing customers to sign up to loyalty program, the method supports mobile devices of customers having short range connectivity and have capability to send SMS messages, but without AT command support, the method comprising the steps of a customer having a mobile device with short range connectivity on (701); the access node recognizing the mobile device with short range connectivity on (702) and the access node sending the mobile device a request for connectivity (703). Once the customer accepts the connectivity request (704), the mobile device is requested by the access node to send an SMS with the short range ID to a predetermined number (706). The short range ID is a unique combination of the customers' phone number along with the Bluetooth ID of the mobile device. The customer also has an option to send his name and email ID over short range connectivity to the access node (705); with the access node on receiving the message, requesting the mobile device to send a SMS with the short range ID to a predetermined number (706). Once the customer accepts the request, a SMS is sent to the server (707). The customer's mobile number along with short range ID is stored in the server (708). The server sends an SMS to the customer confirming his participation in loyalty program (709). The access node sends a WAP push to customers asking them to download an application specific to the mobile device, the application being associated with the unique ID (710). The application is transferred to the customers' mobile device over WAP/short range radio through the access node, the application being encoded with the unique ID based on the Bluetooth id and mobile number (711). The customer downloads the application and installs the same on the mobile device (712). On the customer opening the application for the first time (713); the access node directs the mobile application to send an SMS message to the server with Bluetooth id without the intervention of the customer (714). The server provisions the application and registers the customer for loyalty program (715) when the application signature matches with the application signature stored on the server, the application signature being based on the Bluetooth id and mobile number originally obtained from the customer's mobile device. The application signature is included in every request that goes from the client application on the mobile devices to the server.

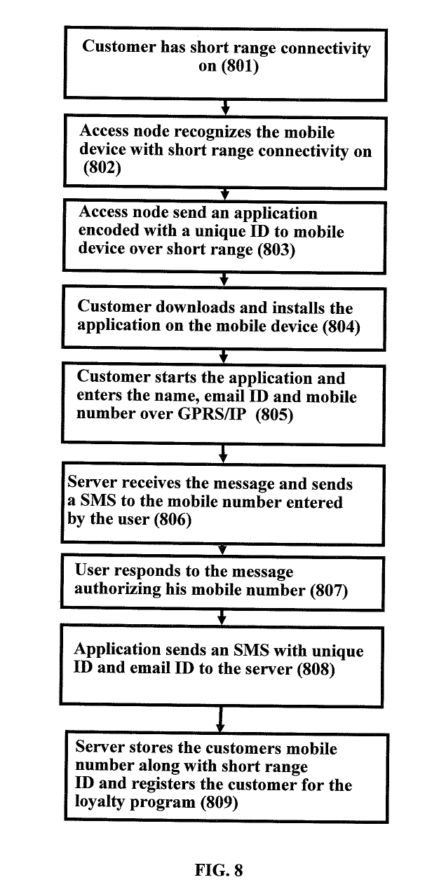

FIG. 8 shows the flow for another embodiment of the method for identifying and reaching new and existing customers to sign up to loyalty program, the method supports mobile devices of customers that having short range connectivity and have capability to send SMS messages, but without AT command support, the method comprising the steps of a customer having a mobile device with short range connectivity on (801); the access node recognizing the mobile device with short range connectivity on (802); the access node sending an application encoded with a unique ID to the mobile device over short range (803); the customer downloading and installing the application on his mobile device (804), the application being encoded with the unique ID based on the Bluetooth id and mobile number of the customer; the customer starting the application and entering his name, email ID and mobile number over GPRS/IP to the server (805); the server receiving the message and sending a text message to the mobile number entered by the customer (806); user responding to the message authorizing his mobile number (807); the application sending a text message with unique ID and email ID to the server (808); the server storing the customers mobile number along with short range ID and registers the customer to the loyalty program (809) when the application signature matches with the application signature stored on the server, the application signature being based on the Bluetooth id and mobile number originally obtained from the customer's mobile device. The application signature is included in every request that goes from the client application on the mobile devices to the server.

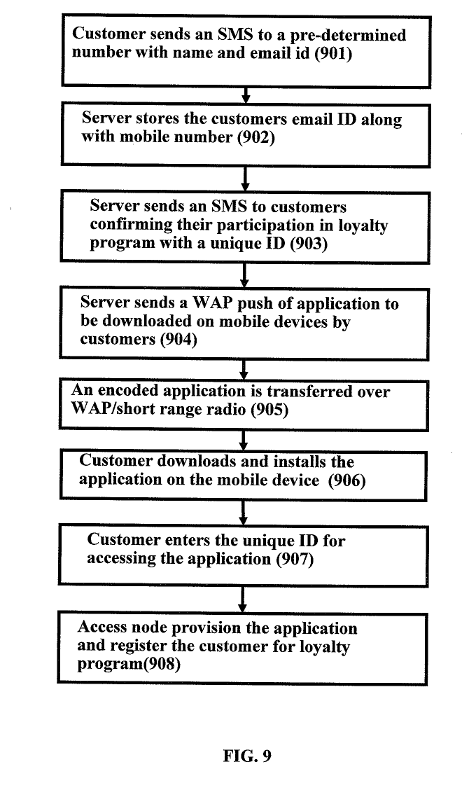

FIG. 9 shows the flow for another embodiment of the method for identifying and reaching new and existing customers to sign up to loyalty program, the method supports mobile devices of customers that do not have short range connectivity, but has the capability to send text messages, the method comprising the steps of the customer sending a text message containing his name and email ID in a specified format to a predetermined number (901); the server storing the customers email ID along with his mobile number (902); the server sending an SMS to the customer confirming their application in the loyalty program with a unique ID (903); the server sending a WAP push of the application to be downloaded on the mobile device by the customer (904), the application being encoded with a unique ID based on the Bluetooth id and mobile number of the customer; the encoded application being downloaded and installed on the mobile device (905) by the customer; the customer entering the unique ID for accessing the application (906); the access node provisioning the application and registering the customer for the loyalty program (907) when the application signature matches with the application signature stored on the server, the application signature being based on the Bluetooth id and mobile number originally obtained from the customer's mobile device. The application signature is included in every request that goes from the client application on the mobile devices to the server.

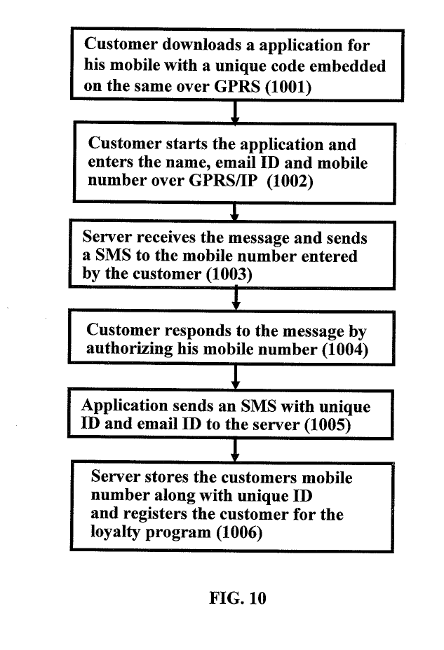

FIG. 10 shows the flow for another embodiment of the method for identifying and reaching new and existing customers to sign up to loyalty program, the method supports mobile devices of customers that do not have short range connectivity, but has the capability to send text messages, the method comprising the steps of the customer downloading an application on his mobile device with a unique ID embedded in the application over GPRS/IP (1001), wherein instead of GPRS/IP, any equivalent method can be utilized; the customer starting the application and entering his name, email ID and mobile number over GPRS/IP (1002); the server receiving the message and sending a SMS to the mobile number entered by the user (1003); the customer responding to the SMS by authorizing his mobile number (1004); the application sending a SMS with the unique ID and email ID to the server (1005) and the server storing the customers mobile number along with the unique ID and registering the customer for the loyalty program (1006) when the application signature matches with the application signature stored on the server, the application signature being based on the Bluetooth id and mobile number originally obtained from the customer's mobile device. The application signature is included in every request that goes from the client application on the mobile devices to the server.

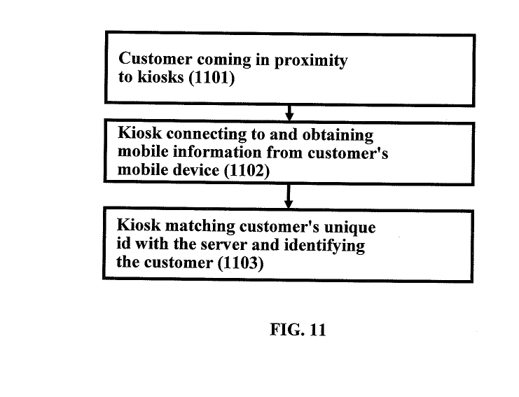

FIG. 11 shows the flow for method of identifying customers signed up for loyalty programs, the method comprising the steps of customer coming in proximity to an access node (1101); access node connecting with the customer's mobile device using short range connectivity and obtaining customer mobile device information (1102); and access node matching customer's unique id (based on Bluetooth id and mobile number) with the server and identifying the customer, where the mobile device of customer supports short range connectivity through Bluetooth (1103).

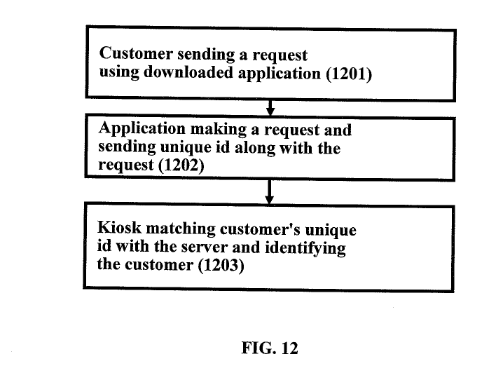

FIG. 12 shows another embodiment of the method of identifying customers signed up for loyalty programs, the method comprising the steps of customer sending a request through an application downloaded from the access node (1201); application making a request based on customer's request to the access node with the unique id (generated by the server originally) (1202); and access node matching the unique id with the server and identifying the customer, where the mobile device of customer does not support short range connectivity through Bluetooth (1203).

In another embodiment, along with Bluetooth id and mobile number, mobile make and model information are also included as part of application signature. This signature is included in every request that goes from the client application on the mobile devices to the server.

In an alternative embodiment, the present invention enables tracking of users at an event (for example in a trade show) to provide relevant and real-time information that the user might be interested including information relating to promotions/discounts offered by businesses based on location and interests of the user.

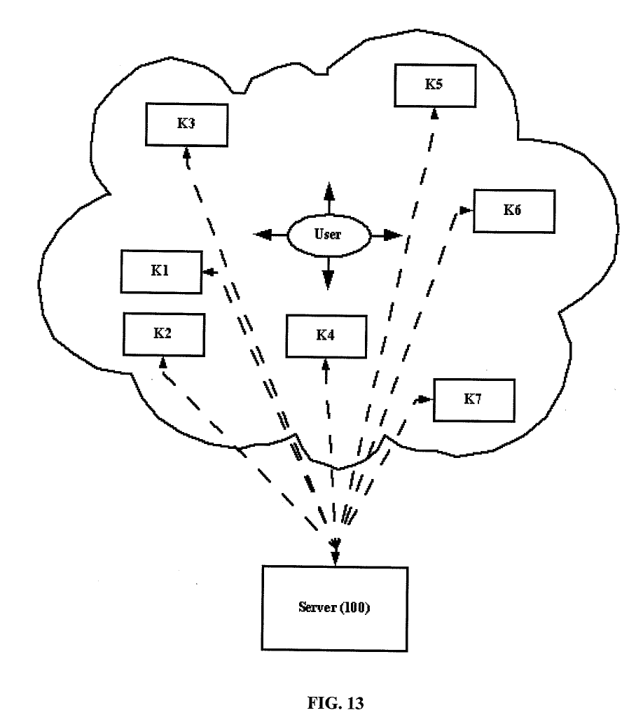

FIG. 13 depicts a physical area where an event is taking place, where K1, K2 . . . K7 represent a plurality of access nodes placed at various locations to cover the geographical area of the event. FIG. 2A shows the basic blocks of an access node comprising of a short range audio sensor (220) to identify mobile devices and other accessories supporting short range radio, a phone controller (202) to communicate with the target device, a delivery manager (204) to manage the delivery of content/information to the target device, a local server (208) to receive messages and information from the client, a streaming engine (206) to handle streaming of files and multimedia to the target mobile devices. An access node also has components such as the device printer (216) to identify the make and model of the system communicating with the system, a formatter (214) to format and encrypt the requests from the access point to the server, a server integrator (212) to regulate the communication between the access node and the server, a local data store (210) to store all the meta information required for the functioning of the access node and a network node manager (218) to manage the functioning of the node as a component of a network comprising of nodes and servers.

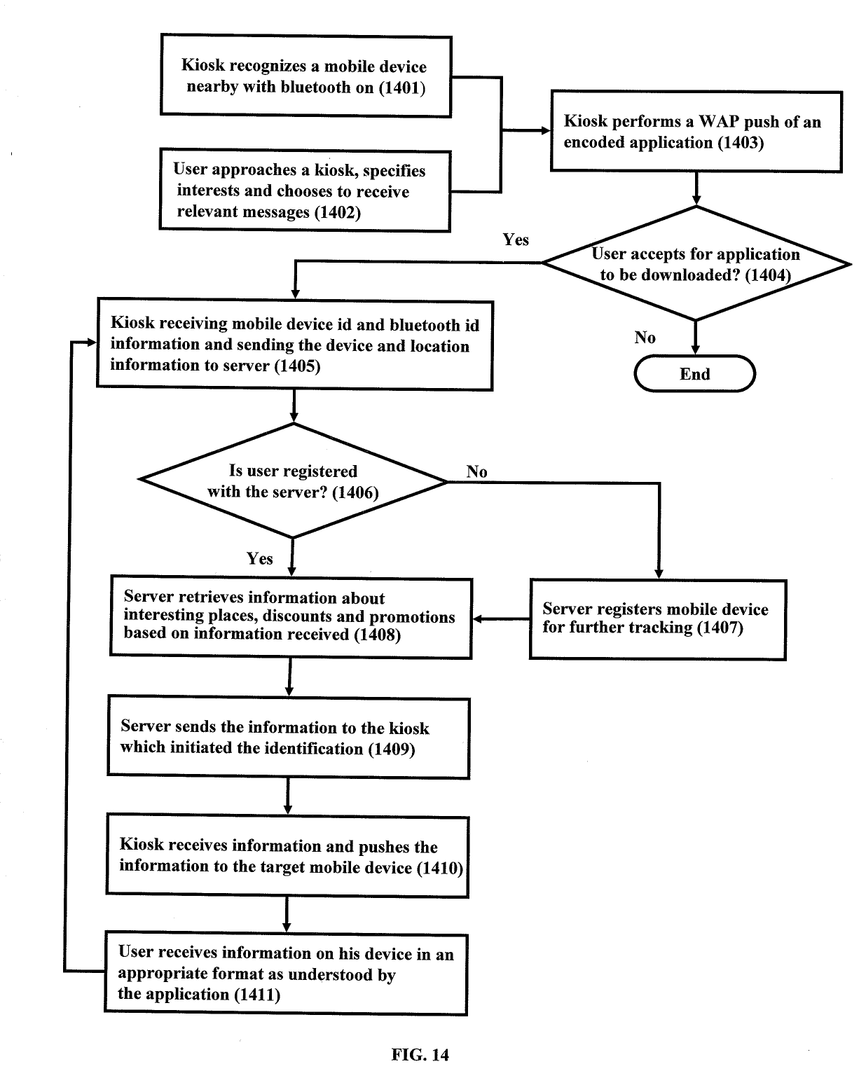

FIG. 13 also depicts a user who is moving around in the area to see the various stalls present in the event (like in a trade show). While the user moves in the area, the moment the user comes close enough to an access node to pickup the short range wireless signal, as shown in FIG. 14, the access node recognizes a mobile device close by with a short range connectivity like Bluetooth activated (1401). Alternatively, the user himself can approach an access node and register to receive useful information about various stalls, their businesses, and any promotions relating to the businesses (1402). In the process, the user may also specify some of his interests in terms of what kind of businesses and products he might be interested in. Upon identification of the device by using the mobile device id, and the unique short range connectivity id (ex: Bluetooth id), access node sending a WAP push to the mobile device requesting the user to download an application specific to the mobile device, the application being encoded with a unique ID (ex: combination of Bluetooth id and mobile number of the mobile device) (1403). Once the user of the mobile device accepts the application download (1404), the information about the mobile device including mobile number and short range connectivity id (ex: Bluetooth id) along with the location information of the mobile device is sent across by the access node to the server 100 at (1405). The server further checks if the mobile is already registered with the server 100 at (1406). If the server does not find the device information already registered with the server, the server registers the mobile device (1407). The registered user's information which can include the user's name, mobile short range radio id, BDADDR wherein Bluetooth is used, mobile number (MSISDN), shopping history is stored in the server. Upon registration of the mobile device, the server retrieves relevant information (1408) to be sent to be sent to the mobile device by mapping the query radio id (BDADDR) to the user information so that the user of the mobile device can use that information productively while participating in the event. The server builds the user profile using the context information sent by the access point. The server sends the information encoded with the unique ID to the access nodes (1409) which initiated the identification of the mobile device. The access node receives the information and pushes the information to the mobile device according the unique ID (1410). The user of the mobile device receives the information and accesses the information through the application downloaded (1411).

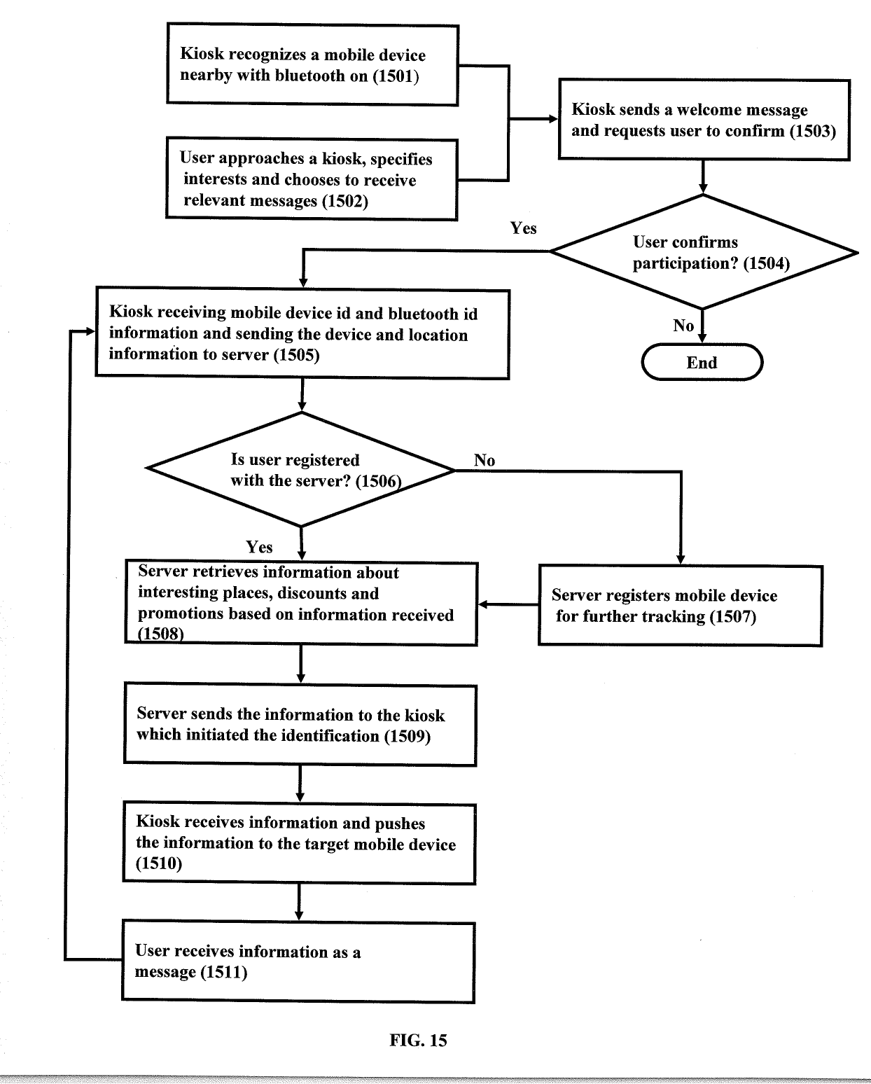

Alternatively, as shown in FIG. 15, when the mobile device does not have the capability to receive a WAP push, the access nodes send a welcome SMS (1503) to the mobile device requesting him to accept participation. The user of the mobile device has a choice to accept or reject participation (1504). The user of the mobile device can accept participation by sending an SMS in a pre-specified format to a pre-specified number. Upon confirmation of participation, the user receives information as SMS. The other steps remain the same as shown in FIG. 14.

A person skilled in the art would appreciate the fact that the same systems and methods can be effectively employed in events other than trade shows, the events including general exhibitions, city tours, conferences etc. to effectively share information including business promotions with participants of the events. For example, in the case of a city tour, the city can track various users traveling through the city, where access nodes can be placed all over the city. Tracking users can be used to understand how users are moving around by using direction/speed/movement analysis based on interaction of users with various access nodes, and which of the places are more preferred compared to others etc. Such information can be used to plan traffic, understand how to make other places more interesting, show the salient features of other places that the tourists have not visited and so on.

The aforementioned systems and methods could be used to identify and reach users to send relevant information including discount coupons and promotion messages based on their previous activity, their likes and dislikes, and their needs. Information about their activities could be accessed through their interaction history, and information obtained from them through feedback. Generating may involve generating inputs based on users action that include recognizing the location of the users, recognizing the visiting pattern, recognizing from where the users are coming, how the users are coming, identifying earlier usages and visiting patterns based on the current identifier amongst other things. Reference may be made to an earlier application U.S. Ser. No. 11/734,302 claiming priority of IN application 1376/CHE/2006 by the inventors, which discloses in detail a model for generating user context. Such context generating models could be used to identify relevant information including discount coupons and promotion messages for users.

In one embodiment, the system could push discount coupons and/or promotional messages to the user through the application downloaded. In another embodiment, the user may request for available discounts and promotions by sending a message using the application.

It will be evident to a person skilled in the art that apart from Bluetooth, the system can support other short range wireless technologies like NFC, IEEE 802.11, Bluetooth, ZigBee, CALM etc. Usage of Bluetooth for explaining various aspects and their embodiments should not be construed as limiting the invention to usage of Bluetooth alone as a short range connectivity mode. And, it will also be evident to a skilled person in the art that it would be possible for servers to communicate with mobile devices via other standard communication protocols like the Internet Protocol. Also, a skilled person in the art would realize that various other modifications to the embodiments described are possible without deviating from the scope and spirit of the invention. And, various examples given as different embodiments are not meant to be mutually exclusive. As is evident, any combinations of the examples both in the method and the system of the invention may be put together to work in accordance with the invention.

What is claimed is:

1. Method to identify and reach users of mobile devices to provide relevant and real-time information, the method comprising the steps of:
a) having a plurality of access nodes deployed to track mobile devices, said access nodes being capable of short range communication and long range communication with mobile devices;
b) having a server connected to said plurality of access nodes to process information obtained by access nodes about mobile devices in range for short range communication between a access node and a mobile device;
c) an access node identifying one or more mobile devices when said one or more mobile devices are in a short range, the short range being conducive to short range communication between said access node and said mobile device; and
d) access node communicating mobile device information with server to obtain appropriate information from the server to deliver to said mobile device,
where information is delivered to mobile devices using short range and long range communication and where the information delivered in relevant and real-time in nature.

2. Method as in claim 1, where short range communication is achieved using Bluetooth.

3. Method as in claim 1, where short range communication is achieved using one of NFC, IEEE, 802.11, CALM.

4. Method as in claim 1, where mobile device information is one or combination of one or more of mobile device unique identifier, unique identifier attached to short range radio frequency, mobile device make, and mobile device model.

5. Method for identifying and reaching new and existing customers to sign up to loyalty program, with a system where a plurality of access nodes are connected to a server, the method comprising the steps of:
a) customers pairing with the system;
b) storing unique ID on the server;
c) server sending an SMS to customers confirming their participation in loyalty program;
d) access node sending a WAP push to customers asking them to download an application specific to the mobile device, the application being associated with the unique ID;
e) transferring the application based on the customers mobile device over WAP through the access node, the application being encoded with the unique ID;
f) customer downloading the application and installing the application;
g) application sending a message with unique ID to server;
h) server provisioning the application and registering the customer for loyalty program when the unique ID matches with the unique ID stored on the server.

6. Method as in claim 5, where pairing of customers includes customers establishing short range connectivity with one of said plurality of access nodes, where the mobile device of the customer is enabled with short range connectivity.

7. Method as in claim 6, where short range connectivity is Bluetooth.

8. Method as in claim 7, the method further comprising the step of access node sending mobile number and Bluetooth id to the server, where mobile devices of customers are Bluetooth enabled.

9. Method as in claim 8, where unique ID is a combination of the Bluetooth id and mobile number.

10. Method as in claim 5, the method further comprising the step of access node using AT commands supported by mobile devices for sending an SMS through the mobile devices to server with the information on Bluetooth id and mobile number of the found device without the intervention of the customer.

11. Method as in claim 5, where in step (g) access node directs the mobile application to send an SMS message to server with unique ID, said message being in a pre-defined format, without the intervention of the customer, where the mobile device is Bluetooth enabled and is capable of sending SMS messages.

12. Method as in claim 5, where in step (g) access node directs the mobile application to send an data packet to server with unique ID, said message being in a pre-defined format, without the intervention of the customer, where the mobile device is Bluetooth enabled and is not capable of sending SMS messages.

13. Method as in claim 5, where pairing of customers includes customer sending an SMS in a predefined format showing his interest to participate in loyalty program, where mobile devices of customers do not have short range connectivity and have capability to send SMS messages.

14. Method as in claim 13, the method further comprising the step of server sending an SMS with a unique id (generated by the server) to customers confirming their participation in loyalty program.

15. Method as in claim 14, the method further comprising the step of customer entering a unique id that he received through the SMS that confirmed the customer's participation in loyalty program, where mobile devices have no short range connectivity and have capability to send SMS messages.

16. Method as in claim 13, where the unique ID is a randomly generated unique identifier generated by the server.

17. Method as in claim 5, where short range connectivity is one of NFC, IEEE, 802.11, CALM.

18. Method of identifying customers singed up for loyalty programs, the method comprising the steps of:
a) customer coming in proximity to an access node;
b) access node connecting with the customer's mobile device using short range connectivity and obtaining customer mobile device information; and
c) access node matching customer's unique ID with the server and identifying the customer,
where the mobile device of customer supports short range connectivity through Bluetooth.

19. Method as in claim 18, where short range connectivity is Bluetooth.

20. Method as in claim 19, where unique ID is a combination of Bluetooth id and mobile number.

21. Method as in claim 18, where short range connectivity is one of NFC, IEEE, 802.11, Bluetooth, ZigBee, CALM.

22. Method of identifying customers singed up for loyalty programs, the method comprising the steps of:
a) customer sending a request through an application downloaded from the access node;
b) application making a request based on customer's request to the access node with the unique ID; and
c) access node matching the unique ID with the server and identifying the customer;
where the mobile device of customer does not support short range connectivity.

23. Method as in claim 22, where the unique ID is a randomly generated unique identifier generated by the server.

24. Method of tracking users in an event, with a system where a plurality of access nodes are connected to a server, the method comprising the steps of:
a) access node connecting to a mobile device using a short range connectivity;
b) access node sending a WAP push to the mobile device requesting the user to download an application specific to the mobile device, the application being encoded with a unique ID;
c) access node sending the unique ID along with the location information of the mobile device to the server;
d) the server further checking if the mobile is already registered with the server;
e) the server registering the mobile device, if the server does not find the device information already registered with the server;
f) the server retrieving relevant information and sending the information encoded with the unique ID to the access node which initiated the identification of the mobile device.
g) access node receiving the information and pushing the information to the mobile device by using the unique ID;
h) user of the mobile device receiving the information and accessing the information through the application downloaded.

25. Method as in claim 24, where short range connectivity is Bluetooth.

26. Method as in claim 25, where unique ID is a combination of Bluetooth id and mobile number of the mobile device.

27. Method as in claim 24, the method further comprising the step of user approaching an access node and registering to receive relevant information.

28. Method as in claim 27, the method further comprising the step of user specifying some of his interests through the access node.

29. Method as in claim 24, where short range connectivity is one of NFC, IEEE, 802.11, Bluetooth, ZigBee, CALM.

30. Method as in claim 24, the method further comprising the steps of:
a) access node sending a welcome SMS to the mobile device requesting user of the mobile device to accept participation to receive relevant information;
b) user of the mobile device has a choice to accepting to participate by sending an
SMS in a pre-specified format to a pre-specified short code or mobile number; and
c) user receiving confirmation information in SMS,
where mobile device of user is not capable of receiving data over WAP.

31. A system to enable identifying and reaching users to provide relevant and real-time information, where users are identified through their mobile devices, the system comprising:
a) a plurality of access nodes, for interaction with mobile devices of users to provide relevant and real-time information;
b) a server for storing, processing and communicating user information and information programs; and
c) plurality of mobile devices of users with at least a radio for short range connectivity.

32. A system as in claim 31, where an access node comprises of:
a) a short range radio sensor identify mobile devices and other accessories supporting the short range radio. When identified, all the captured information is sent to other processing components of the access node;
b) a delivery manager to manage the delivery of content/information to mobile devices or applications running on mobile devices;
c) a phone controller to communicate with the target device using the mechanisms such as AT commands to realize some of the provisioning functionalities like sending an SMS requesting a call back amongst other things;
d) a short range local server to receive messages and information from users;
e) a streaming engine to handle streaming of data, and multi media to target mobile devices;
f) a configuration manager to store information delivered by server on configuration;
g) a local data store to store meta information required for functioning of the access node;
h) a formatter to format and encrypt requests from an access point to server;
i) a device printer to identify make and model of device communicating with the system and to fine tune the mode and format of communication with the device;
j) a server integrator communicate with server both on demand and at scheduled intervals for retrieving communication instructions and polling any configuration details; and
k) a network node integrator to integrate nodes into a mesh network to enable interaction of other nodes with in system with users.

33. A system as in claim 32, where an access node further comprises of a touch screen monitor for user interaction.
